(19) United States
(12) Patent Application Publication
(10) Pub. No.: US 2021/0024845 A1
(43) Pub. Date: Jan. 28, 2021

(54) Systems and Methods for Torrefaction of Biomass

(71) Applicant: Equatorial Equity Capital Partners, Inc., Leawood, KS (US)

(72) Inventor: Jeffrey NOLAND, Leawood, KS (US)

(21) Appl. No.: 16/935,622

(22) Filed: Jul. 22, 2020

Related U.S. Application Data
(60) Provisional application No. 62/876,982, filed on Jul. 22, 2019.

(51) Int. Cl. C10L 9/08; B01J 6/00; B01J 19/00; C01B 3/02; G05B 13/02

(52) U.S. Cl. CPC C10L 9/083; B01J 6/008; B01J 19/0033; C01B 3/02; G05B 13/02; C10L 2290/02; B01J 2219/00234; C10L 2290/06; C10L 2290/58; B01J 2219/00157; B01J 2219/002; B01J 2219/00202; B01J 2219/00238; C10L 2200/0469

(57) ABSTRACT

A biomass torrefaction system includes a reactor vessel for biomass particles, a burner for combusting one or more fuels to produce a heated gas, a fan for supplying a flow of the heated gas through the reactor vessel to heat the biomass particles, and a controller configured to calculate a torrefaction index according to one or more sensed parameters of the system. The sensed parameter(s) include at least one of a reactor vessel retention time, a reactor vessel temperature difference and a higher heating value (HHV) of a syngas output by the reactor vessel. The controller is also configured to automatically adjust one or more operation values of the system according to the calculated torrefaction index. The operation value(s) include at least one of the reactor vessel retention time, a heating rate of the system, and a mixture of the one or more fuels combusted by the burner.

### CROSS-REFERENCE TO RELATED APPLICATIONS

This patent application claims the benefit of U.S. Provisional Patent Application No. 62/876,982 filed on 22 Jul. 2019, the entire disclosure of which is incorporated herein by reference.

### FIELD

The present invention relates to systems and methods for torrefaction of biomass, in particular systems and methods of controlling torrefaction of biomass.

### BACKGROUND

Typical torrefaction processes involve a thermo-chemical treatment of biomass in a low oxygen or an oxygen free environment generally at a temperature between 200° C. to 400° C. During torrefaction the biomass is converted into a product referred to as “torrefied biomass” or “bio-coal,” which has an increased fuel quality for combustion and gasification applications. For example, water contained in the biomass as well as superfluous volatiles are removed as a combustible gas, and the biopolymers (commonly cellulose, hemicellulose and lignin) partly decompose giving off various types of volatiles resulting in a partial loss of mass and an increase in friability. For example, the overall moisture content in the torrefied biomass can be lowered to about 3%. Torrefaction also causes a reaction within the remaining cellular structure that enhances the moisture resistance of the product. The volatiles or combustible gas, also referred to as synthesis gas (syngas), released during torrefaction can be recycled and used to provide heat for the torrefaction process.

In order for a torrefaction process to be commercially viable, it must produce a consistent product with respect to energy density, friability and water resistance and do so economically. Current torrefaction processes rely on operators to assess the torrefaction process quality and make adjustments to several concurrent control loops and to the syngas burner flow rate as the process runs, which can lead to inconsistencies and errors in production. As a result, current torrefaction processes can suffer from under-performance in terms of finished biomass quality, syngas quality, and overall operating cost. Thus, improved torrefaction methods are needed to consistently and efficiently produce torrefied biomass as well as improved syngas quality for use during the process.

### SUMMARY OF THE INVENTION

According to one aspect of the present disclosure, a biomass torrefaction system includes a reactor vessel for conveying biomass particles, a burner for combusting one or more fuels to produce a heated gas, and a fan for supplying a flow of the heated gas through the reactor vessel to heat the biomass particles. The reactor vessel includes an inlet and an outlet. The system also includes a controller having a processor and memory for storing computer-executable instructions. The processor is configured to execute the instructions to calculate a torrefaction index according to one or more sensed parameters of the system. The one or more sensed parameters include at least one of a reactor vessel retention time, a reactor vessel temperature difference and a higher heating value (HHV) of a syngas output by the reactor vessel. The processor is also configured to automatically adjust one or more operation values of the system according to the calculated torrefaction index. The one or more operation values include at least one of the reactor vessel retention time, a heating rate of the system, and a mixture of the one or more fuels combusted by the burner.

According to another aspect of the present disclosure, a method for controlling a biomass torrefaction system is disclosed. The method includes conveying biomass particles through a reactor vessel, where the reactor vessel includes an inlet and an outlet. The method also includes producing a heated gas using one or more fuels combusted by a burner, supplying a flow of the heated gas through the reactor vessel to heat the biomass particles via a fan, and calculating, by a controller, a torrefaction index according to one or more sensed parameters of the system. The one or more sensed parameters include at least one of a reactor vessel retention time, a reactor vessel temperature difference and a higher heating value (HHV) of a syngas output by the reactor vessel. The method further includes automatically adjusting, by the controller, one or more operation values of the system according to the calculated torrefaction index. The one or more operation values include at least one of the reactor vessel retention time, a heating rate of the system and a mixture of the one or more fuels combusted by the burner.

According to another aspect of the present disclosure, a non-transitory computer-readable medium stores instructions executable by a processor, wherein the instructions include calculating a torrefaction index according to one or more sensed parameters of a biomass torrefaction system. The biomass torrefaction system includes a reactor vessel for conveying biomass particles, a burner for combusting one or more fuels to produce a heated gas, and a fan for supplying a flow of the heated gas through the reactor vessel to heat the biomass particles. The one or more sensed parameters include at least one of a reactor vessel retention time, a reactor vessel temperature difference and a higher heating value (HHV) of a syngas output by the reactor vessel. The instructions also include automatically adjusting one or more operation values of the system according to the calculated torrefaction index. The one or more operation values include at least one of the reactor vessel retention time, a heating rate of the system, and a mixture of the one or more fuels combusted by the burner.

Other embodiments, including particular aspects of the embodiments summarized above, will be evident from the detailed description that follows.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic diagram of a torrefaction system according one example embodiment of the disclosure.

FIG. 2 is flow chart of an example method for controlling a torrefaction system according to another example embodiment of the disclosure.

FIG. 3 is a block diagram of a controller for implementing the process of FIG. 2.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” “attached to,” or “coupled to” another element or layer, it may be directly on, engaged, connected, attached or coupled to the other component, element, or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

I. Torrefaction System

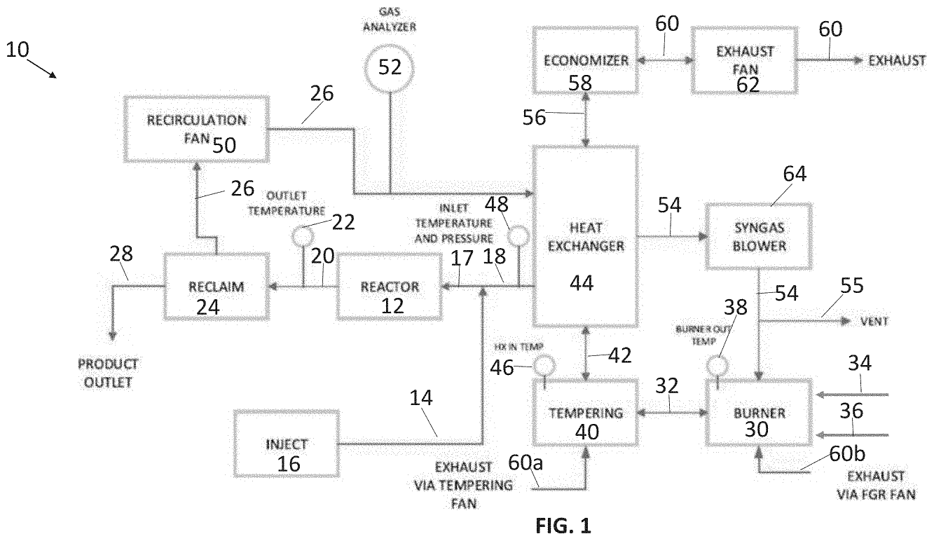

FIG. 1 shows a schematic of a torrefaction system 10 according to one example embodiment of the present disclosure. The system 10 includes a reactor vessel 12 for receiving and heating a biomass feed stream 14 from biomass vessel 16. Suitable biomass feedstocks for exemplary processes and systems disclosed herein include harvested plant materials exemplified by hardwood trees and softwood trees, which may have been processed into chips and/or sawdust and/or pellets, including briquettes, and/or debris and wood waste from wood-processing operations, fibrous annual or perennial crops such as Salix, switchgrass, corn stover, straws produced from harvesting of cereals and/or oilseed crops; or material obtained from waste streams produced from fruit processing plants or vegetable processing plants or cereals processing plants or oilseeds processing plants, or obtained from bagasse from sugar cane. Also suitable are biosolids materials. As used herein, “biosolids” means any solid or semisolid organic material recovered from sewage or wastewater during a sewage treatment process, obtained from municipal sewage treatment processes, or alternatively, may be agricultural wastes from livestock and poultry production. Prior to torrefaction, biomass, such as wood chips can be ground to a consistent chip size, for example, about 1 inch×1 inch×¼ inch, and then dried to have an entering moisture content of less than or equal to about 10%.

The reactor vessel further includes a reactor inlet (not shown) for receiving biomass particles that are to be processed. The biomass feed stream 14 may be fed to the reactor inlet via a conveyor or other conventional material transport mechanism. In one embodiment, a plug-feed screw conveyor may be used to create a plug of material that acts as a seal when passing biomass particles through the inlet. Additionally or alternatively, the biomass feed stream 14 may be flowed with a heated gas stream 18 in combined stream 17 into the reactor vessel 12. It is also contemplated herein that the heated gas stream 18 and the biomass feed stream 14 may enter the reactor vessel 12 simultaneously through the same inlet or the heated gas stream 18 and the biomass feed stream 14 may be separately delivered into the reactor vessel 12 through different inlets.

The reactor vessel 12 may be any suitable reactor for heating the biomass in the presence of heating gas stream 18 and converting it to torrefied biomass. For example, the reactor vessel 12 may be a reactor drum, such as a rotating dryer drum that can rotate along its longitudinal axis. The reactor vessel 12 may include flighting or baffles within it that deflects or attenuates the flow of the biomass through the reactor vessel 12. As the drum rotates, the biomass is picked up and dropped into a column of heating fluid.

The system 10 further includes a burner 30 disposed upstream of the reactor vessel 12 for producing a combustion gas stream 32. For example, a fuel stream 34 and oxygen-containing stream 36 can be provided to burner 30 to produce combustion gas stream 32, a combustion reaction product, for example, containing carbon dioxide, water, nitrogen, or a combination thereof. The oxygen-containing stream 36 can be any suitable stream containing oxygen, for example, air. The fuel stream 34 can be any suitable fuel, such as propane, natural gas, or a combination thereof. In any embodiment, the combustion gas stream 32 can exit the burner 30 at a high temperature, for example, greater than or equal to about 1600° F. or greater than or equal to about 1800° F., as measured by first sensor 38.

Thus, the combustion gas stream 32 can undergo cooling in a tempering vessel 40 to a suitable temperature, for example, about 1450° F., to produce a cooled combustion gas stream 42 before entering a heat exchanger 44. For example, the tempering vessel 40 may be any suitable vessel for mixing the combustion gas stream 32 with a cooler gas stream, for example, a recycled first portion of exhaust gas stream 60a, for cooling the combustion gas stream 32 The temperature of the cooled combustion gas stream 42 prior to entering the heat exchanger 44 can be measured by a second sensor 46. Heat exchanger 44 may be any suitable heat exchanger, for example, a tubular heat exchanger (e.g., a shell and tube heat exchanger) or a plate heat exchanger (e.g., plate and frame heat exchanger). Cooled combustion gas stream 42 may undergo further cooling in the heat exchanger 44 to produce the heated gas stream 18 for heating the biomass feed stream 14. For example, heated gas stream 18 may be at a temperature of about 800° F. to about 1000° F. as the heated gas stream 18 enters the reactor vessel 12. Pressure and/or temperature at the inlet of reactor vessel 12 of the heated gas stream 18 may be measured by a third sensor 48.

During operation, the heated gas stream 18 acts as a thermal fluid to carry heat energy to the biomass particles within the reactor vessel 12 and to provide momentum for conveyance of the biomass particles. The heated gas stream 18 may also heat the internal structure of the reactor vessel 12, especially the lifting flights, which may also in turn heat the biomass particles. The flow of the heated gas stream 18 is driven by a recirculating fan 50, for example, a typical industrial fan. As the biomass particles are heated and react within the reactor vessel 12, the volatile components in the biomass particles vaporize to form syngas. The compositions of the syngas can depend on the type of biomass undergoing torrefaction. In any embodiment, the syngas may comprise hydrocarbons, lactic acid, carbon, hydrogen, carbon monoxide, carbon dioxide, and combinations thereof. The syngas generated can also simultaneously heat and react with the biomass particles as well as convey the biomass particles toward an outlet (not shown) of the reactor vessel 12. Thus, a product stream 20 comprising torrefied biomass and syngas can exit the reactor vessel 12 via a reactor outlet (not shown). The temperature of the product stream 20 can be about 350° F. to about 750° F. or about 600° F. as it exits the reactor vessel 12 as measured by a fourth sensor 22.

Product stream 20 may undergo separation in a reclaim vessel 24 to separate solids from the gas, in particular, solid torrefied biomass 28 stream may be recovered from syngas stream 26. Reclaim vessel 24 may be any suitable separator for separating solids from a gas. For example, reclaim vessel 24 may include a dropout/deceleration chamber and a dust collector. Solid torrefied biomass 28 may undergo further processing, such as cooling and pelletization.

The syngas stream 26 may then be circulated to the heat exchanger 44 via recirculation fan 50. Prior to entry into the heat exchanger 44, the properties and composition the syngas stream 26 can be analyzed in one or more gas analyzer(s) 52. For example, the gas analyzer(s) can determine the oxygen and water vapor concentration (i.e., humidity) in the syngas stream 26. In heat exchanger 44, syngas stream 26 may be heated to a suitable temperature (e.g., about 800° F. to about 1,000° F.) by exchanging heat with cooled combustion stream gas stream 42 as it flows through heat exchanger 44 to produce heated syngas stream 54. For example, when the heat exchanger 44 is a shell and tube heat exchanger, the syngas stream 26 may flow through the tubes and the cooled combustion gas stream 42 may flow in the shell portion surrounding the tubes and heat the syngas flowing in the tubes. At least a portion of the cooled combustion gas stream 42 may exit the heat exchanger 44 after heating the syngas as spent combustion gas stream 56, for example, at a temperature of about 800° F. The spent combustion gas stream 56 may be sent to economizer 58 (e.g., a heat exchanger) to produce exhaust gas stream 60 which can be circulated via an exhaust fan 62. The exhaust gas stream 60 may comprise carbon dioxide and water vapor. In economizer 58, the spent combustion gas stream 56 can be cooled to produce exhaust gas stream 60 and heat from the spent combustion gas stream 56 can be used to heat water, which then can be used in a first stage dryer. A first portion of exhaust gas stream 60a optionally may be recycled and supplied to the tempering vessel 40 to cool the combustion gas stream 32 via a tempering fan (not shown). Additionally or alternatively, a second portion of exhaust gas stream 60b optionally may be recycled and supplied to burner for cooling via a flue gas recycle (FGR) fan (not shown).

Depending on the higher heat value (HHV) of the heated syngas stream 54 as further descried below, the heated syngas stream 54, may be: (i) advantageously provided to the burner 30 to use a further fuel stream supplementing the fuel stream 34, (ii) vented out of the system 10 via vent stream 55, or (iii) both (i) and (ii). The heated syngas stream 54 may be provided to the burner 30 via syngas blower 64. It is also contemplated herein that the syngas blower 64 can be operated to modulate the pressure in reactor vessel 12. The system 10 may also include a controller as further described below.

II. Methods of Controlling Biomass Torrefaction

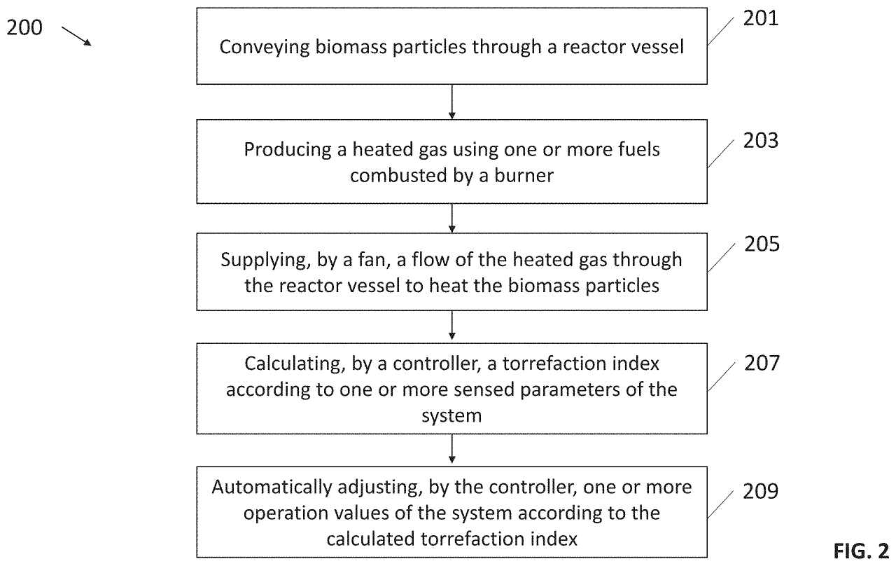

FIG. 2 illustrates an example method 200 for controlling a biomass torrefaction system (e.g., for controlling the system 10, etc.). The method 200 includes, at 201, conveying biomass particles through a reactor vessel, where the reactor vessel includes an inlet and an outlet. For example, biomass particles may be conveyed through the reactor vessel 12 of FIG. 1, etc.

At 203, the method 200 includes producing a heated gas using one or more fuels combusted by a burner. For example, burner 30 of FIG. 1 can produce heated gas which may under cooling in the tempering vessel 40 and the heat exchanger 44 prior to entering the reactor vessel 12. At 205, the method 200 includes supplying, by a fan, a flow of the heated gas through the reactor vessel to heat the biomass particles. As shown in FIG. 1, heated gas may be propelled through the reactor vessel 12 using one or more fans at any suitable location, such as the inlet to the reactor vessel 12, in the heat exchanger 44, in the syngas blower 64, at the recirculation fan 50, etc.

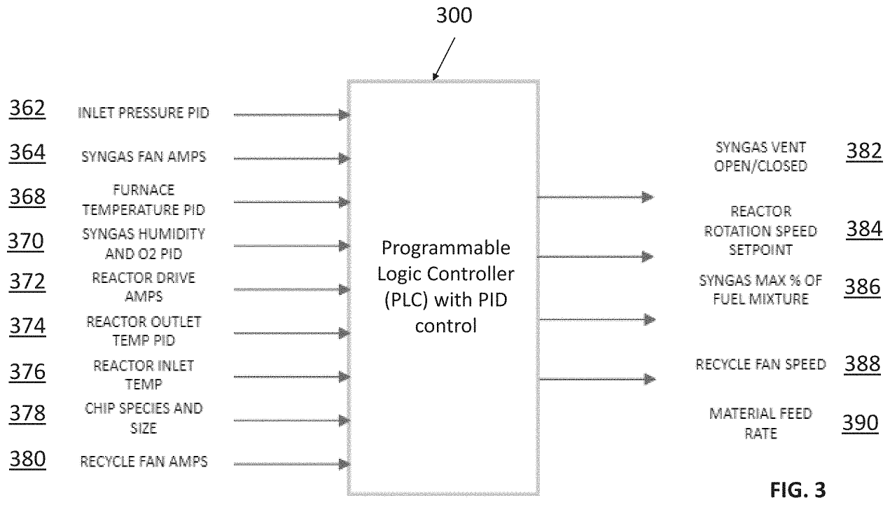

At 207, the method 200 includes calculating, by a controller, a torrefaction index according to one or more sensed parameters of the system. The one or more sensed parameters include at least one of a reactor vessel retention time, a reactor vessel temperature difference (i.e., difference in temperature between reactor inlet and reactor outlet) and a higher heating value (HHV) of a syngas output by the reactor vessel. For example, FIG. 3 illustrates an example controller 300 for calculating a torrefaction index, as explained further below.

The method 200 also includes, at 209, automatically adjusting one or more operation values of the system according to the calculated torrefaction index. The one or more operation values include at least one of the reactor vessel retention time, a heating rate of the system, and a mixture of the one or more fuels combusted by the burner. Reactor vessel retention time, also referred to as residence time, refers to the amount of time the biomass is heated and/or reacted within the reactor vessel. A heating rate of the system refers to the rate of firing the burner, for example, 30 MMBTU/hour. The heating rate represents the thermal demand of the reaction at any given point. Mixture of the one or more fuels refers to the amount of each of the one or more fuels combusted by the burner. In other words, adjusting the mixture of the one or more fuels can include increasing and/or decreasing the amount of each of the one or more fuels supplied to the burner for combustion.

FIG. 3 illustrates an example controller 300 for executing the method 200. As shown in FIG. 3, the controller is a programmable logic controller (PLC) that includes inputs for receiving sensor values indicative of the sensed parameter(s), and outputs for automatically adjusting the operation parameter(s) via one or more control signals. The controller 300 may include proportional-integral-derivative (PID) control (e.g., a PID control function, etc.), for automatically adjusting the one or more operation values according to the determined torrefaction index using PID control.

Although FIG. 3 illustrates a PLC controller, other embodiments may include any suitable controller for controlling a torrefaction system. For example, the controller 300 may include any suitable microprocessor, microcontroller, integrated circuit, digital signal processor, etc., which may include memory. The controller 300 may be configured to perform (e.g., operable to perform, etc.) any of the example processes described herein using any suitable hardware and/or software implementation. For example, the controller 300 may execute computer-executable instructions stored in a memory, may include one or more logic gates, control circuitry, etc., as described above.

As shown in FIG. 3, example sensed parameters may include a gas pressure 362 at the inlet of the reactor vessel (e.g., the inlet of the reactor vessel in FIG. 1, etc.), a current 364 through the fan that supplies the flow of heated gas through the reactor vessel, a temperature 368 of the burner (e.g., the burner 30 of FIG. 1, etc.), a humidity and an oxygen concentration 370 of the syngas output by the reactor vessel (e.g., syngas stream 26 of FIG. 1, etc.), a current 372 used to drive the reactor vessel, a gas temperature 374 at the outlet of the reactor vessel (e.g., at the outlet of the reactor vessel 12 in FIG. 1, etc.), a gas temperature 376 at the inlet of the reactor vessel, a size and/or species 378 of the biomass particles, a current 380 through a fan used to drive recycled syngas output by the reactor vessel (e.g., the recirculation fan 50 in FIG. 1), etc.

Inputs of the controller 300 may be coupled to any suitable sensors to receive the sensed parameters. For inputs of the controller 300 may be coupled to the gas analyzer 52 in the system 10 of FIG. 1, to the outlet temperature sensor 22, to the inlet temperature and pressure sensor 48, to the heat exchanger input temperature sensor 46, to the burner output temperature sensor 38, etc.

The inlet gas pressure 362 may be measured using PID factors, which can provide a historical measurement of the volume of syngas that has been produced, an instantaneous measurement of the volume of syngas being produced, a forecasted or predicted volume of syngas that will be produced, etc. For example, the PID factors of the sensed inlet gas pressure 362 may be used to determine whether the volume of syngas is increasing or decreasing.

The current 364 of the syngas fan (e.g., the syngas blower 64 of FIG. 1, etc.), is indicative of the power required to operate the syngas fan. Instantaneous measurements, forecasted measurements, etc., may be used to determine the volume and density of the syngas that is being produced. In some embodiments, the sensed current 364 of the syngas fan may be combined with the sensed inlet gas pressure 362 to make a more accurate determination of the syngas volume that is being produced.

The furnace temperature 368 may include PID factors that measure an amount of heat being produced in the furnace (e.g., in the burner 30 of FIG. 1), using the current mixture of fuels (e.g., the fuel stream 34 and oxygen-containing stream 36, and possibly the heated syngas stream 54 of FIG. 1, etc.). This measurement may be indicative of a combustion quality of the syngas. For example, if incoming syngas is increasing the measured furnace temperature 368, this may indicate that the syngas has a desirable higher heating value (HHV) to contribute to combustion. As used herein, “higher heating value (HHV)” (also referred to as gross calorific value) refers to the amount of heat released when a fuel (e.g., syngas stream described herein) is combusted and condensing any vapor products and the products have returned to a pre-combustion temperature, for example, a temperature of 25° C. If the incoming syngas is decreasing the measured furnace temperature 368, this may indicate that the syngas has an undesirable HHV and is inhibiting combustion (e.g., because the humidity of the syngas is too high, because the oxygen content of the syngas is too low, etc.). In any embodiment, a desirable HHV can be greater than or equal to about 3,500 BTU/lb, greater than or equal to about 4,000 BTU/lb, or greater than or equal to about 4,500 BTU/lb; or from about 3,500 BTU/lb to about 4,000 BTU/lb.

The syngas humidity and oxygen content measurements 370 may include PID factors that determine the quality of the syngas stream, such as an HHV value of the syngas for determining whether a portion of the syngas should be used for combustion in the burner. The syngas humidity and oxygen content measurements 370 may be combined with the furnace outlet temperature measurement 368 to more accurately determine a quality of the syngas, an HHV of the syngas, etc. In some embodiments, a flow rate of syngas to the burner may be sensed to provide a precise measurement of the amount of syngas being used to produce heat.

The reactor current 372 may be measured as an amount of Amps drawn, etc., which may represent a total mass of biomass particles in the reactor vessel. For example, the reactor vessel 12 of FIG. 1 may include a reactor drum having multiple flights for attenuating a flow of the biomass particles through the reactor drum. Measuring an amount of current drawn by a motor of the reactor may indicate the amount of power needed to rotate the drum, where more power is needed when a greater mass of biomass particles is located in the drum.

Alternatively, the reactor vessel 12 may include a jacketed screw conveyor including a helical screw blade, etc. Measuring an amount of current drawn by a motor of the screw conveyor may indicate the amount of power needed to rotate the helical screw blade, etc., where more power is needed when greater number of biomass particles are located in the conveyor. The reactor current 372 may be indicative of a residence time of the particles in the reactor (e.g., where higher current moves the particles through the reactor faster, etc.).

The reactor outlet temperature 374 may include PID factors, which can measure the degree to which the critical torrefaction process temperature is being maintained, a direction of the reaction (e.g., increasing or decreasing in temperature), etc. For example, this measurement may indicate whether the torrefaction process is remaining stable.

The reactor outlet temperature 376 may be used for comparison with the reactor outlet temperature 374 to determine a temperature difference across the reactor. This temperature difference may be combined with measurements of the current 372 drawn by the reactor, the current 380 drawn by the recycle fan, etc., to provide a representation of a residence time in the reactor vessel.

The chip species and size 378 may indicate the type of biomass particle being used, which may impact the HHV for the syngas. For example, juniper and pine wood chips may result in different syngas properties, etc. The chip species and size 378 may affect set points for the reactor and recycle fan speeds, and may be related to residence time of the biomass particles in the reactor vessel, etc.

The current 380 drawn by the recycle fan (e.g., the recirculation fan 50 of FIG. 1, etc.), may be indicative of the density of the syngas vapor. The current 380 may also indicate the material load of the reactor (e.g., the amount of biomass particles in the reactor vessel 12 of FIG. 1, etc.).

FIG. 3 also illustrates example outputs of the controller 300, which may use control signals to control different aspects of the torrefaction system. For example, the controller 300 may provide control signals to the reactor vessel 12 of the system 10 of FIG. 1, to the burner 30, to the syngas blower 64, to the recirculation fan 50, to the biomass vessel 16, to the syngas vent 56, etc.

The control signal 382 opens or closes the syngas vent (e.g., the vent 55 in FIG. 1, etc.). For example, if too much syngas builds up, the vent may be opened to vent syngas from the system to atmosphere. If the syngas quality is not high enough (e.g., the HHV is too low for sufficient combustion in the burner 30, etc.), the vent 55 may be opened to allow the syngas to escape.

If the syngas will be used for combustion, the vent may be closed to allow the syngas to flow to the burner. In that case, a syngas flow control valve may be opened to allow a percentage of syngas into the burner. For example, the control signal 386 may specify a maximum percentage of the fuel mixture in the burner 30 that can be syngas (e.g., fifty percent, ninety-five percent, or any suitable value). In any embodiment, the syngas can make up at least about 50%, preferably greater than or equal to about 75%, more preferably greater than or equal to about 90%, of fuel mixture and the balance of the fuel mixture may be the fuel stream 34 (e.g., propane and/or natural gas). In some cases, the vent 55 may be opened at the same time the flow control valve to the burner is open, so that a portion of the syngas is vented and a portion of the syngas is combusted in the burner 30.

The control signal 384 controls a rotation speed of the reactor, and the control signal 388 may control a speed of the recycle fan. For example, the controller 300 may control the rotation of the reactor vessel 12 to increase or decrease the residence time of the biomass particles in the reactor vessel 12, and the control the speed of the recirculation fan 50 to modify the rate of heat transfer within the system 10.

The control signal 390 may control the feed rate of biomass particles from the biomass vessel 16 to the reactor vessel 12. For example, when the torrefaction process is at an upper or lower limit, the feed rate may be decreased or increased. In some embodiments, when the speed of the reaction vessel 12 is at an upper or lower limit, the speed of the recirculation fan 50 may be increased or decreased.

In some embodiments, the controller 300 may be configured to use multiple regression to solve multiple linear equations corresponding to a species and chip size of the biomass particles to compute a torrefaction index. For example, the torrefaction index may include a percentage of retention time versus a target value, multiplied by a percentage of a target temperature difference across the reactor vessel, multiplied by a percentage of a target outlet temperature, etc. The controller 300 may receive a torrefaction index set point via user input, compare the calculated torrefaction index to the received torrefaction index set point, and automatically adjust the one or more operation values according to a difference between the calculated torrefaction index and the received torrefaction index set point.

For example, the torrefaction index may be used as an input to a PID function to determine an average value and a rate of change, to provide additional input to control loop settings. The torrefaction index is then fed into a function generator that determines the higher heat value of the syngas. This value is further fed into a function generator to establish the maximum amount of syngas that can be fired in the furnace (e.g. burner 30 in FIG. 1, etc.), as a percentage of total heat. For example, if the torrefaction index is designated as ‘1’ for a desired ‘good’ torrefaction process, the HHV may be approximately 4,300 BTU/lb, etc. The determination of how much syngas may be fired as the torrefaction index changes may depend on firing performance characteristics of the burner.

Example embodiments described herein may assimilate critical process data of the torrefaction system and automatically adjust control loop set points to effectively control the torrefaction process. For example, sensed parameters described herein may be combined into a linear equation to calculate the torrefaction index, and the calculated torrefaction index may be used to automatically adjust set points for control of components of torrefaction system, to optimize efficiency, etc. The torrefaction index may optimize energy usage in the system to minimize an amount of commercial fuel combusted by the burner while maintaining sufficient torrefaction of the biomass particles, etc. This may reduce operating cost, improve syngas quality, increase finished biomass quality, etc., as compared to imperfections an errors that may occur when a human operator manually controls the torrefaction process, etc.

In another example embodiment, a non-transitory computer-readable medium stores instructions executable by a processor, wherein the instructions include calculating a torrefaction index according to one or more sensed parameters of a biomass torrefaction system. The biomass torrefaction system includes a reactor vessel for conveying biomass particles, a heat exchanger for heating gas using one or more fuels combusted by a burner, and a fan for supplying a flow of the heated gas through the reactor vessel to heat the biomass particles. The one or more sensed parameters include at least one of a reactor vessel retention time, a reactor vessel temperature difference and a higher heating value (HHV) of a syngas output by the reactor vessel. The instructions also include automatically adjusting one or more operation values of the system according to the calculated torrefaction index. The one or more operation values include at least one of the reactor vessel retention time, a heating rate of the system, and a mixture of the one or more fuels combusted by the burner.

The instructions may include receiving a torrefaction index set point via user input, calculating the torrefaction index includes using multiple regression to solve multiple linear equations corresponding to a species and chip size of the biomass particles, and automatically adjusting the one or more operation values includes comparing the calculated torrefaction index to the received torrefaction index set point, and automatically adjusting the one or more operation values according to a difference between the calculated torrefaction index to the received torrefaction index.

In some embodiments, automatically adjusting the one or more operation values includes supplying the calculated torrefaction index to a proportional-integral-derivative (PID) function to determine an average value and a rate of change of the torrefaction index, and adjusting, based on an output of the PID function, at least one of: a speed of rotation of the reactor to increase or decrease a residence time of the biomass particles in the reactor; a speed of a fan for recycling syngas output by the reactor to modify a rate of heat transfer within the system; a total firing rate of the burner; a percentage of syngas allowed to be fired in the burner; an open or closed position of a vent for venting syngas from the system to atmosphere; an open or closed position of a flow control valve for allowing or stopping a flow of the syngas to the burner; and an infeed rate of the biomass particles to an inlet of the reactor.

Automatically adjusting the one or more operation values may include supplying the calculated torrefaction index to a proportional-integral-derivative (PID) function to determine an average value and a rate of change of the torrefaction index, determining the HHV of the syngas according to the calculated torrefaction index, and calculating a maximum amount of syngas for combusting with the one or more fuels in the burner as a percentage of total heat.

All publications, patent applications, issued patents and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A method for controlling a biomass torrefaction system, the method comprising:
conveying biomass particles through a reactor vessel, the reactor vessel including an inlet and an outlet;
producing a heated gas using one or more fuels combusted by a burner;
supplying, by a fan, a flow of the heated gas through the reactor vessel to heat the biomass particles;
calculating, by a controller, a torrefaction index according to one or more sensed parameters of the system, the one or more sensed parameters including at least one of a reactor vessel retention time, a reactor vessel temperature difference and a higher heating value (HHV) of a syngas output by the reactor vessel; and
automatically adjusting, by the controller, one or more operation values of the system according to the calculated torrefaction index, the one or more operation values including at least one of the reactor vessel retention time, a heating rate of the system, and a mixture of the one or more fuels combusted by the burner.

2. The method of claim 1, wherein the controller comprises a proportional-integral-derivative (PID) controller and automatically adjusting the one or more operation values includes automatically adjusting the one or more operation values according to the determined torrefaction index using PID control.

3. The method of claim 1, wherein the controller comprises a programmable logic controller (PLC) including at least one input for receiving a sensor value indicative of the one more sensed parameters, and at least one output for automatically adjusting the one or more operation parameters via one or more control signals.

4. The method of claim 1, wherein the reactor vessel comprises a reactor vessel drum including multiple flights for attenuating a flow of the biomass particles through the reactor vessel drum, and the method further comprises rotating the reactor vessel drum according to a rotation speed set point.

5. The method of claim 1, wherein the reactor vessel comprises a jacketed screw conveyor including a helical screw blade, and conveying the biomass particles includes rotating the helical screw blade to convey the biomass particles through the jacketed screw conveyor.

6. The method of claim 1, wherein the one or more sensed parameters include at least one of:
a gas pressure at the inlet of the reactor vessel;
a current through the fan that supplies the flow of heated gas through the reactor vessel;
a temperature of the burner;
a humidity and an oxygen concentration of the syngas output by the reactor vessel;
a current used to drive the reactor vessel;
a gas temperature at the outlet of the reactor vessel;
a gas temperature at the inlet of the reactor vessel;
a size and/or species of the biomass particles; and
a current through a fan used to drive recycled syngas output by the reactor vessel.

7. The method of claim 1, wherein the one or more operation values at least one of:
an open or closed position of a vent that vents the syngas out of the system to atmosphere;
a rotation speed of the reactor vessel;
a percentage of the syngas that is combusted with the one or more fuels in the burner;
a speed of a fan used to drive recycled syngas output by the reactor vessel; and
a feed rate of the biomass particles into the inlet of the reactor vessel.

8. The method of claim 1, wherein calculating the torrefaction index includes sensing the one or more sensed parameters of the system using one or more sensors, and the one or more sensors include at least one of a gas pressure sensor positioned at the inlet of the reactor vessel, a gas temperature sensor positioned at the outlet of the reactor vessel, a gas temperature sensor positioned at an outlet of the burner, a gas temperature sensor positioned at an input to a heat exchanger, and a gas analyzer positioned in a flow of recirculated syngas from the outlet of the reactor vessel.

9. The method of claim 1, wherein:
the method further comprises receiving a torrefaction index set point via user input;
calculating the torrefaction index includes using multiple regression to solve multiple linear equations corresponding to a species and chip size of the biomass particles; and
automatically adjusting the one or more operation values includes comparing the calculated torrefaction index to the received torrefaction index set point, and automatically adjusting the one or more operation values according to a difference between the calculated torrefaction index to the received torrefaction index.

10. The method of claim 9, wherein automatically adjusting the one or more operation values includes:
supplying the calculated torrefaction index to a proportional-integral-derivative (PID) function to determine an average value and a rate of change of the torrefaction index;
determining the HHV of the syngas according to the calculated torrefaction index; and
calculating a maximum amount of syngas for combusting with the one or more fuels in the burner as a percentage of total heat.

11. The method of claim 1, wherein automatically adjusting the one or more operation values includes:
supplying the calculated torrefaction index to a proportional-integral-derivative (PID) function to determine an average value and a rate of change of the torrefaction index; and
adjusting, based on an output of the PID function, at least one of:
a speed of rotation of the reactor vessel to increase or decrease a residence time of the biomass particles in the reactor vessel;
a speed of a fan for recycling syngas output by the reactor vessel to modify a rate of heat transfer within the system;
a total firing rate of the burner;
a percentage of syngas allowed to be fired in the burner;
an open or closed position of a vent for venting syngas from the system to atmosphere;
an open or closed position of a flow control valve for allowing or stopping a flow of the syngas to the burner; and
an infeed rate of the biomass particles to the inlet of the reactor vessel.

12. A biomass torrefaction system, the system comprising:
a reactor vessel for conveying biomass particles, the reactor vessel including an inlet and an outlet;
a burner for combusting one or more fuels to producing a heated gas;
a fan for supplying a flow of the heated gas through the reactor vessel to heat the biomass particles; and
a controller including a processor and memory for storing computer-executable instructions, wherein the processor is configured to execute the instructions to:
calculate a torrefaction index according to one or more sensed parameters of the system, the one or more sensed parameters including at least one of a reactor vessel retention time, a reactor vessel temperature difference and a higher heating value (HHV) of a syngas output by the reactor vessel; and
automatically adjust one or more operation values of the system according to the calculated torrefaction index, the one or more operation values including at least one of the reactor vessel retention time, a heating rate of the system, and a mixture of the one or more fuels combusted by the burner.

13. The system of claim 12, further comprising at least one of a gas pressure sensor positioned at the inlet of the reactor vessel, a gas temperature sensor positioned at the outlet of the reactor vessel, a gas temperature sensor positioned at an outlet of the burner, a gas temperature sensor positioned at an input to a heat exchanger, and a gas analyzer positioned in a flow of recirculated syngas from the outlet of the reactor vessel.

14. The system of claim 12, wherein:
the reactor vessel comprises a reactor vessel drum including multiple flights for attenuating a flow of the biomass particles through the reactor vessel drum, or a jacketed screw conveyor including a helical screw blade; and
the controller comprises a programmable logic controller (PLC) including at least one input for receiving a sensor value indicative of the one more sensed parameters, at least one output for automatically adjusting the one or more operation parameters via one or more control signals, and a proportional-integral-derivative (PID) control function for automatically adjusting the one or more operation values.

15. The system of claim 12, wherein:
the one or more sensed parameters include at least one of a gas pressure at the inlet of the reactor vessel, a current through the fan that supplies the flow of heated gas through the reactor vessel, a temperature of the burner, a humidity and an oxygen concentration of the syngas output by the reactor vessel, a current used to drive the reactor vessel, a gas temperature at the outlet of the reactor vessel, a gas temperature at the inlet of the reactor vessel, a size and/or species of the biomass particles, and a current through a fan used to drive recycled syngas output by the reactor vessel; and
the one or more operation values include at least one of an open or closed position of a vent that vents the syngas out of the system to atmosphere, a rotation speed of the reactor vessel, a percentage of the syngas that is combusted with the one or more fuels in the burner, a speed of a fan used to drive recycled syngas output by the reactor vessel, and a feed rate of the biomass particles into the inlet of the reactor vessel.

16. The system of claim 12, wherein:
calculating the torrefaction index includes using multiple regression to solve multiple linear equations corresponding to a species and chip size of the biomass particles; and
automatically adjusting the one or more operation values includes comparing the calculated torrefaction index to a torrefaction index set point received via user input, and automatically adjusting the one or more operation values according to a difference between the calculated torrefaction index to the received torrefaction index.

17. A non-transitory computer-readable medium storing instructions executable by a processor, wherein the instructions include:
calculating a torrefaction index according to one or more sensed parameters of a biomass torrefaction system, the biomass torrefaction system including a reactor vessel for conveying biomass particles, a burner for combusting one or more fuels to produce a heated gas, and a fan for supplying a flow of the heated gas through the reactor vessel to heat the biomass particles, the one or more sensed parameters including at least one of a reactor vessel retention time, a reactor vessel temperature difference and a higher heating value (HHV) of a syngas output by the reactor vessel; and
automatically adjusting one or more operation values of the system according to the calculated torrefaction index, the one or more operation values include at least one of the reactor vessel retention time, a heating rate of the system, and a mixture of the one or more fuels combusted by the burner.

18. The non-transitory computer-readable medium of claim 17, wherein:
the instructions include receiving a torrefaction index set point via user input;
calculating the torrefaction index includes using multiple regression to solve multiple linear equations corresponding to a species and chip size of the biomass particles; and
automatically adjusting the one or more operation values includes comparing the calculated torrefaction index to the received torrefaction index set point, and automatically adjusting the one or more operation values according to a difference between the calculated torrefaction index to the received torrefaction index.

19. The non-transitory computer-readable medium of claim 17, wherein automatically adjusting the one or more operation values includes:
supplying the calculated torrefaction index to a proportional-integral-derivative (PID) function to determine an average value and a rate of change of the torrefaction index;
determining the HHV of the syngas according to the calculated torrefaction index; and
calculating a maximum amount of syngas for combusting with the one or more fuels in the burner as a percentage of total heat.

20. The non-transitory computer-readable medium of claim 17, wherein automatically adjusting the one or more operation values includes:
supplying the calculated torrefaction index to a proportional-integral-derivative (PID) function to determine an average value and a rate of change of the torrefaction index; and
adjusting, based on an output of the PID function, at least one of:
a speed of rotation of the reactor vessel to increase or decrease a residence time of the biomass particles in the reactor vessel;
a speed of a fan for recycling syngas output by the reactor vessel to modify a rate of heat transfer within the system;
a total firing rate of the burner;
a percentage of syngas allowed to be fired in the burner;
an open or closed position of a vent for venting syngas from the system to atmosphere;
an open or closed position of a flow control valve for allowing or stopping a flow of the syngas to the burner; and
an infeed rate of the biomass particles to an inlet of the reactor vessel.
